(19) United States
(12) Patent Application Publication
(10) Pub. No.: US 2013/0346163 A1
(43) Pub. Date: Dec. 26, 2013

(54) AUTOMATICALLY MEASURING THE QUALITY OF PRODUCT MODULES

(71) Applicants: JOHANN KEMMER, Muehlhausen (DE); Martina Rothley, Schwetzingen (DE)

(72) Inventors: JOHANN KEMMER, Muehlhausen (DE); Martina Rothley, Schwetzingen (DE)

(21) Appl. No.: 13/530,110

(22) Filed: Jun. 22, 2012

(51) Int. Cl. G06Q 10/00

(52) U.S. Cl. 705/7.41

(57) ABSTRACT

Various embodiments of systems and methods for measuring the quality of individual product modules over a lifecycle of a product are described herein. The method involves integrating error reports received from an internal incident management system and a customer incident management system. The method further includes associating the quality information in the error reports to a corresponding one or more product modules of a product and storing the association in a metadata repository. Using the quality information from the metadata repository, an automated evaluation of the quality of a product module is performed. In an aspect, the quality of a product module is represented as a quality indicator which is normalized with respect to a usage index of the product module. The generated quality indicator for the product module is associated with the product module and stored in the metadata repository with a time stamp for later access.

### FIELD

The field relates generally to product development tools. More specifically, the field relates to automatically measuring and tracking the quality of product modules over a lifecycle of a product.

### BACKGROUND

Product quality measurement and control has become extremely important for the reliability and acceptance of the product in the market. This has been acknowledged since decades and particularly has been emphasized recently in modern product development. Particularly, very early in product lifecycle, quality is one of the cornerstones, for which compromises against scope and time for realization are forbidden. However, and despite of initiatives going along with this aim, experience shows, that with the means currently in use, not all failures can be eliminated during product development. For example, due to the complexity of the product, distinct and unforeseen use by the customer, lack of transparency with quality information, and/or outdated quality information, it is improbable if not impossible, to directly and automatically measure the quality of product modules over a lifecycle of the product with the currently used techniques.

### SUMMARY

Various embodiments of systems and methods for automatically measuring and tracking the quality of product modules over a lifecycle of a product are described herein. In an aspect, the method involves integrating error reports received from an internal incident management system and a customer incident management system, where the error reports include quality information relating to one or more product modules. For example, a feed of single incidents, resulting from internal tests or from customer detected malfunction, reporting a software bug, a documentation issue, or unexpected system behavior is received as quality information. The method further includes associating the quality information in the error reports to a corresponding one or more product modules of a product and storing the association in a metadata repository. Using the quality information from the metadata repository, an automated evaluation of the quality of a product module is performed. In an aspect, the quality of a product module is represented as a quality indicator, where the quality indicator is normalized with respect to the usage of the product module relative to the other product modules of the product. In another aspect, the generated quality indicator for the product module is associated with the product module and stored in the metadata repository with a time stamp for later access. In a further aspect, the quality information gathered in the metadata repository is periodically evaluated to generate a quality report for using as a basis for taking strategic measures. In yet another aspect, the quality information gathered in the metadata repository is evaluated using predefined thresholds to automatically trigger actions for improving the quality of a product module.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates a conceptual diagram of the technique for automatically measuring the quality of product modules, according to one embodiment.

FIG. 2 is a flow diagram of a method for automatically measuring and tracking the quality of product modules over a lifecycle of a product, according to one embodiment.

FIG. 3 is a flow diagram of a method for generating a quality indicator for a product module of a product, according to one embodiment.

FIG. 4 illustrates a data flow diagram representing the flow of data within the various components of the quality measuring system.

FIG. 5 illustrates an exemplary interface showing a quality report providing the measured quality indicators, in accordance with an embodiment.

FIG. 6 is a block diagram of an exemplary system for automatically measuring and tracking the quality of product modules, according to one embodiment.

FIG. 7 is a block diagram of an exemplary computer system according to one embodiment.

### DETAILED DESCRIPTION

Embodiments of techniques for automatically measuring and tracking the quality of product modules over a lifecycle of a product are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

The concept underlying the method of measuring the quality of product modules relies on the storage of quality related information directly with the individual product modules in a data repository. The quality related information may be received from both a customer incident management system and an internal incident management system. By associating the quality related information with a corresponding product module, the reliability and transparency of the quality information increases thereby facilitating automatic evaluation and reporting of die quality of individual product modules. Using the quality information, the quality of the individual product modules is measured using an objective method of measurement involving the normalization of quality indicators. In an aspect, the quality indicators may be normalized based on a relative usage of the individual product modules or any individual or vendor-specific weighting of individual product modules. The vendor specific weightings can be determined based on a relative importance individual product modules to the vendor. Further, the quality information stored in the repository may be automated periodically to trigger actions/alerts for improving the product quality. Furthermore, the measured quality indicators may be analyzed and presented as a report for facilitating strategic and long-term measures. The term “product module” as used herein refers to an abstract representation of any encapsulated entity of a product that is subject to quality measurements. Examples of product modules include hardware parts, chips, circuit boards, electronic components, software (s/w) applications, s/w development packages, s/w classes, and s/w methods.

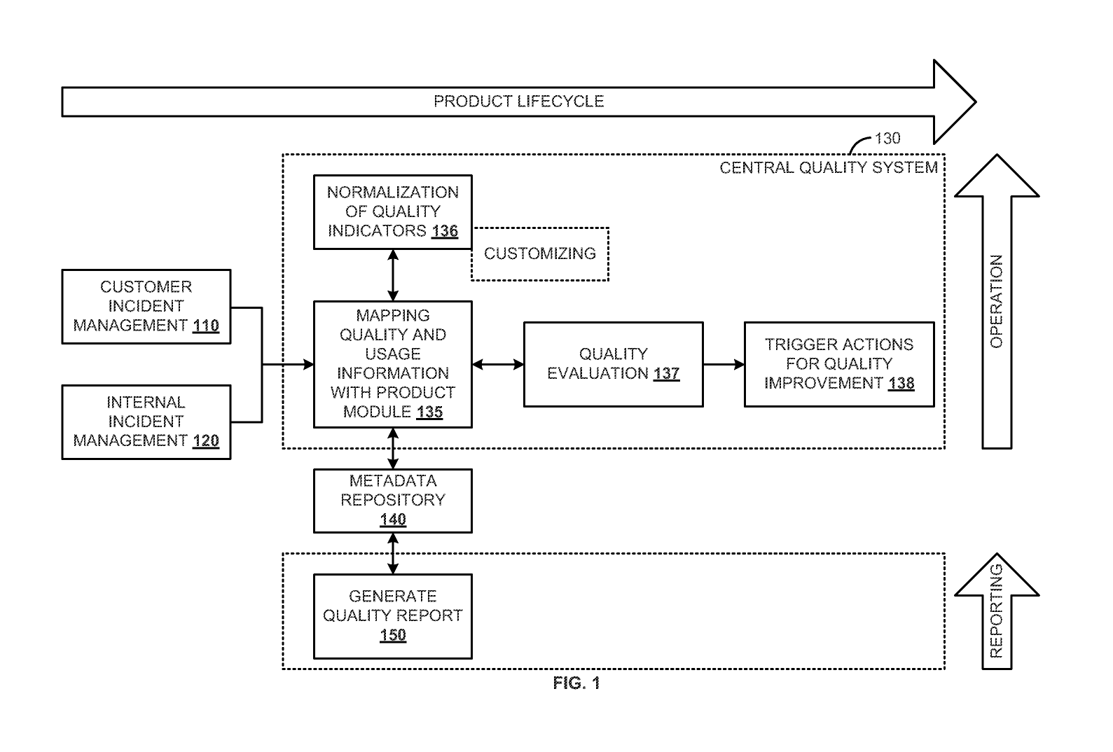

Referring to FIG. 1, a customer incident management system 110 and an internal incident management system 120 are communicatively coupled to a central quality system 130. The customer incident management system 110 is provided by a vendor of a product to a customer of the product. Any information relating to errors occurring in the product that may be detected by a test system or a productive system at the customer premise (on-premise environment or a hosted (on-demand) environment) are reported to the customer incident management system 110. The customer incident management system 110 in-turn feeds the information to the central quality system 130 of the vendor. The internal incident management system 120 is an incident management system in an internal system landscape of the vendor. Errors detected during the product testing or development stages of the product are gathered at the internal incident management system 120. The error reports received from the customer incident management system 110 and/or the internal incident management system 120 are integrated at a mapping module 135 within the central quality system 130.

In an aspect, the mapping module 135 has access to a metadata repository 140 holding information regarding the granularity of product modules across all hierarchical levels. Based on the granularity information provided in the metadata repository 140, the quality information relating to individual product modules are mapped to the corresponding product modules. The quality information refers to information that is indicative of the quality of the product and may the drawn from error reports, incident tickets, customer feedback systems, product support systems, etc. Examples of quality information include no. of errors relating to a product module, severity of errors, errors associated with a certain lifecycle of the product, quality indicators, etc.

Further, the mapping module 135 associates a usage index to each of the respective product modules. The term “usage index” as used herein refers to a count of code processing during runtime, i.e., a count of the number of times a particular product module was used (accessed, executed, etc.) by a user. In an aspect, in order to determine the usage index of a product module, usage index indicators are associated with each of the product modules during development such that information regarding the processing of the coding of interest during runtime is written into the usage indicator. The code processing information written into the usage indicators during runtime provides a measure of the usage of the respective product modules by a user. In an aspect, the usage indicator can be set up at each of the product's lifecycle phases so that the usage of the product module during various phases of the product's lifecycle can be differentiated.

In an aspect, in order to enable consistent and optimal assessment of the quality of individual product modules, the quality indicators are normalized based on one or more factors. Such normalization of quality indicators helps avoid “one size fits all” type of evaluation which generally leads to inaccurate results. Accordingly, in an aspect the quality indicators are normalized at a normalization module 136 as a function of the usage index associated with individual product modules. In an example, a quality indicator for a product module that is used frequently may represent a higher value than a quality indicator for a product module that is used less frequently. This is because, the more a product module is used, the higher the chances of encountering an error. Therefore, in order to perform a consistent evaluation of quality across the various product modules, the quality indicators for the individual product modules are normalized based on the no. of times an individual product module is used. As already mentioned, the usage index provides a count of the number of times the code was processed thereby providing a measure of the usage of the respective product modules. In another aspect, the quality indicators are normalized as a function of pre-defined weights assigned to the product modules during customization. The normalized quality indicators are associated with the corresponding product modules and stored in metadata repository 140 as part of the associated quality information with the product module.

The quality information mapped to the individual product modules are periodically evaluated at a quality evaluation module 137 and one or more error-prone product modules are identified. For example, an aggregate of the quality indicators for a particular product module that were detected at each stage of the product lifecycle, at both the hosted environment and the on-premise environment, is calculated. Based on the aggregated quality indicator at each stage, the quality issues at each point of the lifecycle are addressed in a timely manner. For example, based on the quality indicator determined during a product delivery stage, a decision to stop the delivery of a product module and instead replace it by a new one (based on a better or more solid technology stack) can be made early in the development phase. A threshold for the quality indicator may be pre-defined during customization such that those product modules whose aggregate quality indicators exceed the pre-defined threshold are identified as error-prone product modules and a suitable action or alert is triggered at a triggering module 138 for quality improvement. In an aspect, subsequent to alerting, a code review of the software modules of the detected error-prone modules is performed as a quality control measure. Further, an analytical report is generated periodically at a reporting module 150 based on the quality information stored in the metadata repository 140. The analytical report may include such information as the no. of errors, usage index, quality indicator class, etc., classified according to product family, application, lifecycle status, business object class, and the like. The analytical report provides the basis for strategic and long-term measures such as replacement of applications with new applications based on a newer technology stack.

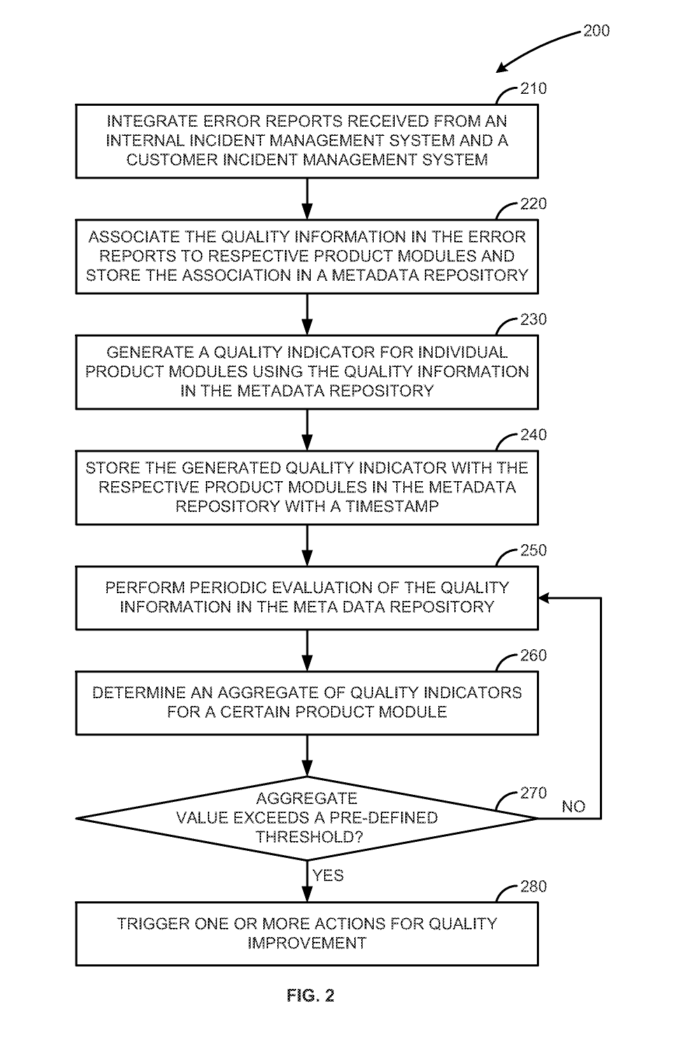

FIG. 2 illustrates a flow diagram of a method 200 for automatically measuring the quality of product modules. The method 200, implemented by a computer or any other electronic device having processing capabilities, includes at least the following process illustrated with reference to process blocks 210-280. The method involves directly and automatically measuring the quality of individual product modules such as software modules by aggregating the quality information gathered at each stage of the software product's lifecycle by test systems and productive systems at both the customer on-premise or on-demand and the internal (vendor) environment. In an aspect, at process block 210, error reports received from an internal incident management system and a customer incident management system are integrated at a central quality system. The error reports hold information indicating the quality of a software module, expressed either as error messages or performance descriptors. Examples of such error reports include incident reports by a test system or a productive system, CSN tickets, internal error logs, and other error reporting features. At process block 220, the quality information derived from the error reports are associated with the respective product modules and stored in a metadata repository. The quality information may be collected from internal or external systems at each of the various stages of the software product's lifecycle and associated with the respective product modules in the metadata repository. Examples of the various stages of the software product include product development, ramp-up, testing, release-to-customer, operation, customer service, etc. Further, the errors identified in the error reports may be classified according to its severity such as high, medium, and minor. In an aspect, as a matter of choice in the customizing, minor errors could be neglected to simplify the process since the minor errors may not directly lead to any action or correction. Further, the errors are counted separately according to certain stages of the product lifecycle. The stages of the product lifecycle may also be defined during customization.

At process block 230, a quality indicator representing the quality of the software modules that is subject to quality measurement, at each lifecycle stage, is generated. In an aspect, the quality indicator is generated using the quality information stored in the metadata repository. In an example, the quality indicator for a software module represents a count of the errors (e.g., weighted by its severity) associated with the software module normalized by its usage and other weighting factors. The errors associated with the software modules are extracted from the quality information associated with the software module in the metadata repository. In an aspect, the quality indicator calculated based on a quality figure such as no. of errors or usage index, for a particular product module, can be automatically updated (re-calculated) when the quality figure is updated. By automatically updating the quality indicator, the system maintains and provides up-to-date quality information for every product module at any given point in time.

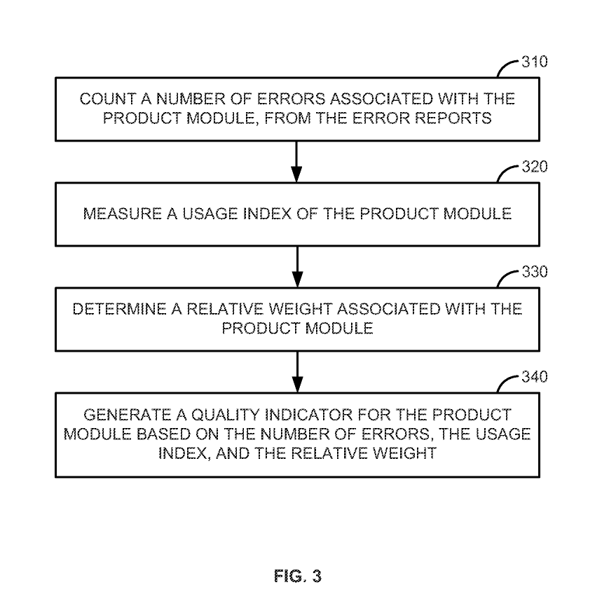

In an embodiment described with reference to the flow diagram shown in FIG. 3, the quality indicators are normalized across the various software modules based on a relative usage of the software modules and individual weights assigned to the software modules. The quality indicator is evaluated as a count of the number of errors associated with a software module, at process block 310. The quality indicator is then normalized by a process illustrated with reference to process blocks 320-340. At process block 320, a usage index of the software product is measured. As mentioned previously, the usage index provides a count of the number of times the code was processed thereby providing a measure of the usage of the respective product modules. In an aspect, the usage index is collected in a hosted on-demand environment. In another aspect, the usage index is provided through a customer on-premise system that is communicatively connected to the vendor's incident management system. In an example, usage index indicators are associated with each of the product modules during development such that information regarding the processing of the coding of interest during runtime is written into the usage indicator.

At process block 330, a relative weight associated with the software module is determined. In an aspect, the relative weighting of the software module is a factor defined by the software vendor for the individual weighting of the software module in comparison to other software modules of the portfolio, according to the software module's significance to either the customer or the vendor. In an aspect, the weighting factor is assigned to the highest level of the product hierarchy (e.g., software application) and cascaded to the lower levels. The weighting factor may be customized individually per software module depending on internal and external parameters. Examples of external parameters contributing to the weighting factor include the frequency of use (e.g., via product licensing) of the application by customers, mission/enterprise critical application for customer, market demand, etc. Examples of internal parameters contributing to the weighting factor include competitive advantage, strategic importance of the application within the organization (e.g., software vendor) with regards to market penetration or to enter anew market or industry, etc.

At process block 340, the quality indicator for the software module is generated as a normalized value using the count of the number of errors, severity of the errors, the usage index, and the relative weight assigned to the software module. In an aspect, the quality indicator may be calculated by classifying the errors based on the severity e.g., high, medium, and minor, and assigning weights to the errors based on the severity. Those errors that are assigned a defined threshold can alone be used for deriving the quality indicator. In an aspect, the quality indicator is calculated according to the following example equation:

Quality Indicator=<[(No. of errors)/(usage Index)]*(relative weight of software module)>

The quality indicator is used as a reference for the measurement of the quality of the software module and can be used further on in quality evaluation and reporting described with reference to FIG. 2.

Referring back to FIG. 2, at process block 240, the generated quality indicator for individual software modules are associated with the respective software modules and stored in the metadata repository with a timestamp for later access. At process block 250, the quality information in the metadata repository is periodically evaluated. In an aspect, based on the evaluation the quality information corresponding to individual software modules are extracted across all hierarchical levels and over various stages of the product's lifecycle. At process block 260, an aggregate of the extracted quality information, e.g., an aggregate of the quality indicators, for each software module is calculated. At decision block 270, the aggregate value of the quality information is compared with a pre-defined threshold value and determined whether the aggregate value exceeds the pre-defined threshold value. In an aspect, the threshold values are defined so as to detect major deviations of individual or aggregated quality indicators, if the aggregate value exceeds the pre-defined threshold value, one or more actions are triggered, at process block 280, in order to take measures to improve the quality of the product module. Examples of such actions include, taking corrective measures, replacing applications, notifying the concerned teams, suggesting improvements in future versions, proactively providing customer support, altering product pricing, etc. Alternatively, if the aggregate value does not exceed the pre-defined threshold value, the process returns to process block 250.

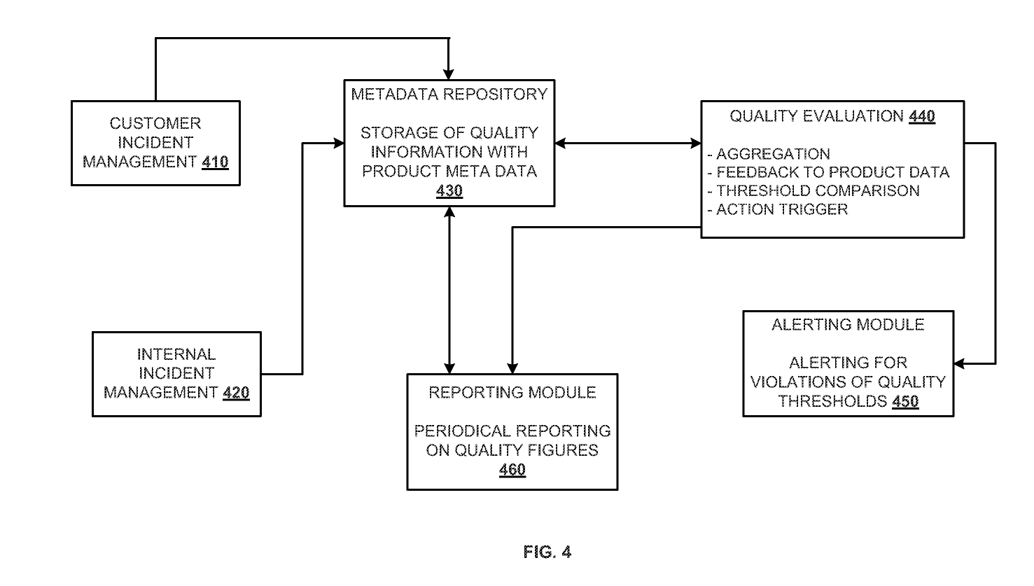

FIG. 4 illustrates a data flow diagram representing the flow of data within the various components of the quality measuring system. In an aspect, one or more error reports having quality information is received from an internal incident management system 420 and a customer incident management system 410 and directly stored with a metadata associated with the individual product module, in a metadata repository 430. The quality information in the metadata repository 430 is accessed for quality evaluation by a quality evaluation module 440 in the central quality system. At the quality evaluation module 440, the quality information accessed from the metadata repository 430 is aggregated for each of the product modules and the aggregate value is compared with a predefined threshold value. The aggregate value may be stored in the metadata repository 430 along with the product metadata. Based on the comparison one or more actions/alerts are triggered by the quality evaluation module 440, in response to the trigger, an alerting module 450 sends out alerts for violations of quality thresholds. Also, suitable tasks for improving the quality of the product modules may be automatically sent out by the alerting module to relevant teams or may trigger sub-processes. Further, based on the quality figures evaluated at the quality evaluation module 440, and the quality information associated with the product modules in the metadata repository 430, a periodical reporting of quality figures is performed by a reporting module 460. In an aspect, the report generation is performed periodically at pre-defined intervals of time. In another aspect, the report generation is performed at each stage of the product's lifecycle. In yet another aspect, the report generation is performed in response to an action trigger requiring a comprehensive quality report.

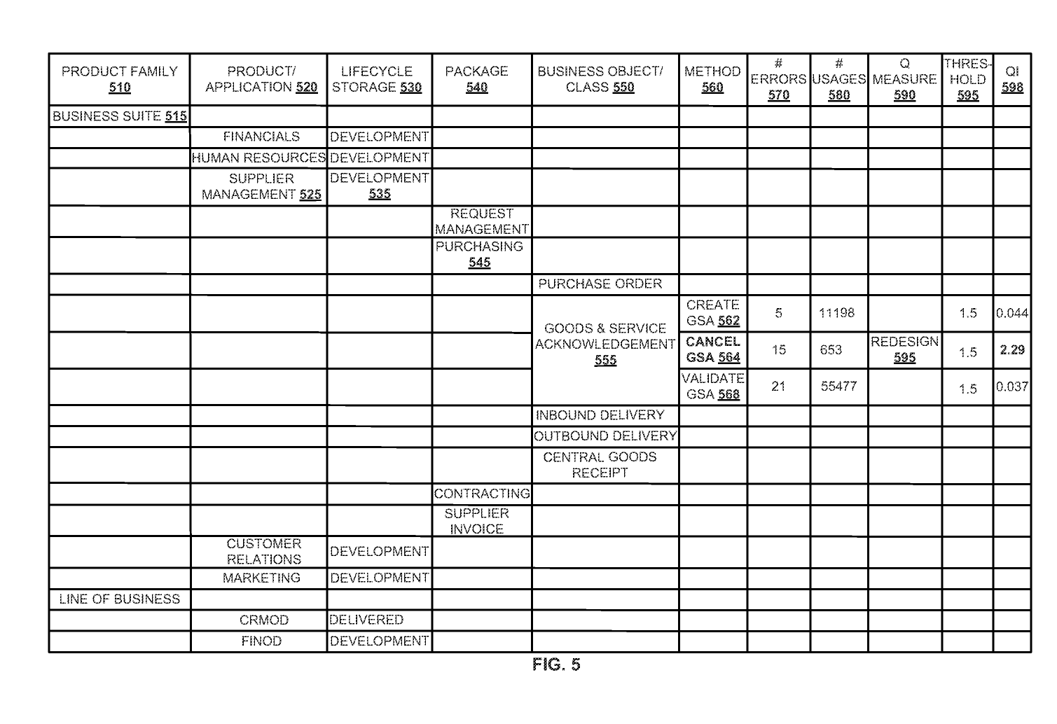

FIG. 5 illustrates an exemplary interface 500 showing a quality report providing the measured quality indicators, in accordance with an embodiment. Reporting complements operational evaluation and may lead to triggering additional measures to improve quality. Based on the aggregated quality indicators in the metadata repository, a reporting will be provided showing details about quality figures across all products combined with the ability to aggregate and display the products and their quality figures according to one or more schemas. Examples of the schemas include product family, product lifecycle, product significance, top ‘n’ products in terms of good quality, top ‘n’ products in terms of poor quality, etc. In the given example, the quality report displays the normalized quality indicators at various aggregational levels with the ability to provide a more granular representation of the quality figures. Due to the storing of quality information directly with the individual product modules or entity it belongs to, the extraction of quality figures is simplified. In an aspect, as shown, the quality report generated by the reporting module is represented in a tabular form with one or more quality attributes representing the fields in the table. The given example illustrates a reporting for a software product. However, other products, domains, and disciplines are well within the scope of the described embodiments. In the given example, the field “# Errors” 570 represents a quality information. Further, the table provides a mapping of the quality indicator 570 values to one or more product related information such as product family 510, product/application 520, lifecycle stage 530, package 540, Business Object/class (product module) 550, method 560, #Usage (usage index) 580, and Q measure (Trigger actions) 590, Threshold 595, and quality indicator (QI) 598.

As shown in the given example, the # errors 570 field holds values 5, 15, and 21, representing the number of errors associated with product module Goods & Services Acknowledgement (GSA) 555. On a more granular level, the values 5, 15, and 21 respectively represent the number of errors associated with the methods “create GSA,” 562 “cancel GSA,” 564 and “validate GSA” 568 of the product module Goods & Services Acknowledgement (GSA) 555. At a higher level, the GSA product module 555 belongs to the package “Purchasing” 545 which belongs to the Application “Supplier management” 525 of the product family “Business Suite” 515. Also, the detected errors are associated with the “In development” lifecycle stage 535, i.e., the errors were detected during the development of the product. Further, the quality measure field 590 displays a correspondingly triggered action, e.g., code inspections “redesign” 595 that is triggered in response to evaluating the “# errors” values. In the given example, the “# errors” value is normalized using the “# usages” value and then represented as a quality indicator (QI) in field 598. In an aspect, the quality indicator may be calculated by classifying the errors based on the severity e.g., high, medium, and minor, and assigning weights to the errors based on the severity. Those errors that are assigned a defined threshold can alone be used for deriving the quality indicator. The QI values in field 598 are compared against a threshold value in the threshold field 595 to trigger appropriate action to control the quality of the product module. As shown in the example, the error values 5, 15, and 21 are normalized by the usage values 11198, 653, and 55477 of the corresponding methods “create GSA,” 562 “cancel GSA,” 564 and “validate GSA” 568. The resulting quality indicators 0.044, 2.29, and 0.037 are respectively compared with the threshold value 1.5, and the product module cancel GSA is highlighted as the error-prone module requiring immediate action.

In another aspect, a follow-up report may be generated to show quality figures collected during the time post the implementation of quality measures that were taken in response to an action triggered during a previous quality evaluation. The follow-up report enables the assessment of the effectiveness of the quality measures taken, so that the measures that were ineffective can be improved upon and the measures that were effective may be emphasized during future undertakings.

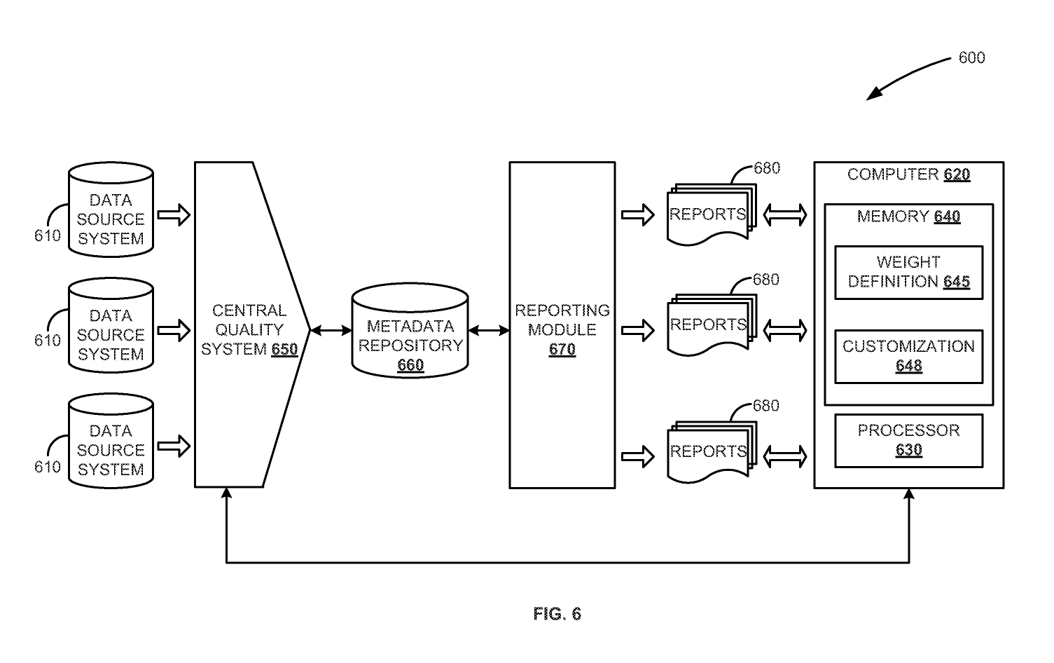

FIG. 6 is a block diagram of an exemplary system for automatically measuring and tracking the quality of product modules, according to one embodiment. The system 600 is communicatively coupled to one or more data source systems 610. Data source systems 610 refer to sources of data that enable data storage and/or retrieval. For example, data source system 610 may include databases, web applications, web server, an incident reporting tool, test system, data server etc. Examples of databases include relational, transactional, hierarchical, multi-dimensional (e.g., OLAP), object oriented databases, and the like. Data source systems 610 may also include data sources where the data is not tangibly stored or otherwise ephemeral such as data streams, broadcast data, and the like. In an embodiment, the system 600 is an on-demand integrated business development system in which software and associated data are hosted centrally, e.g., on the internet and accessed by a computer using a web browser.

In an embodiment, the system 600 includes a computer 620 having a processor 630 and memory 640. The processor 630 executes software instructions or code, for automatically measuring the quality of product modules, stored on a computer readable storage medium such as the memory 640, to perform the above-illustrated methods. The system 600 includes a media reader to read the instructions from the computer readable storage medium 640 and store the instructions in storage or in random access memory (RAM). For example, the computer readable storage medium 640 includes executable instructions for performing operations including, but not limited to, integrating error reports received from an internal incident management system and a customer incident management system, associating the quality information in the error reports to a corresponding one or more product modules of a product and storing the association in a metadata repository, automatically evaluating the quality of a product module using the quality information from the metadata repository, normalizing the quality of the product module, e.g., with respect to the usage of the product module, and storing the quality indicator with a metadata of the corresponding product module in the metadata repository.

In an aspect, the executable instructions for performing the steps of the method are embodied as a central quality system. The central quality system may be implemented as a component within the processor 630 or as a separate component external to the processor 630. In the given example, the central quality system 650 is implemented as a separate component external to the processor 630, however, controlled by the software instructions stored in the memory 640 of the computer 620. Based on the instructions, the central quality system 650 integrates the quality information received from the data source systems 610 and stores the quality information in a metadata repository 660 communicatively coupled to the central quality system 650. The quality information integrated at the central quality system 650 is associated with individual product modules based on information regarding the various product modules across all hierarchical levels. The association of the quality information with the product modules is also stored in the metadata repository 660. Further, based upon instructions in the memory 640, the central quality system 650 evaluates a quality indicator for each of the product modules based on the quality information associated with the individual product modules in the metadata repository 660.

In an aspect, the quality indicator represents count of the no. of errors occurring within a particular product module, which is derived from the quality information associated with that particular product module. The quality indicator is then normalized using a usage index that may also be received from the customer incident reporting system and stored in the metadata repository 660 by the computer 620. Further, a weight definition module 645 in the memory 640 holds pre-defined relative weighting factors based on which the processor 630 assigns a relative weight to the individual product modules. The central quality system 650 normalizes the quality indicator using the usage index and the weight assigned to the corresponding product module. In an example, the quality indicator is normalized as a product of (the quotient of the no. of errors (weighted by its severity) with the usage index) and the assigned relative weight of the product component.

The central quality system 650 then aggregates the normalized quality indicators for individual product modules across the various stages of the product's lifecycle and stores the aggregate value in the metadata repository 660 with a timestamp. Further, based on predefined thresholds defined in the customization module 648 in memory 640, the central quality system compares the aggregate quality indicators with the predefined thresholds. Based on the comparison, the central quality system triggers one or more actions or alerts to the relevant teams, or invokes sub-process for improving the quality of the product.

Further, a reporting module 670 executes instructions stored in the memory 640, to periodically evaluate the quality information tied to each of the product modules, in the metadata repository 660. Based on the evaluation the reporting module 670 generates one or more reports 680 and renders the reports on an output interface of the computer 620.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

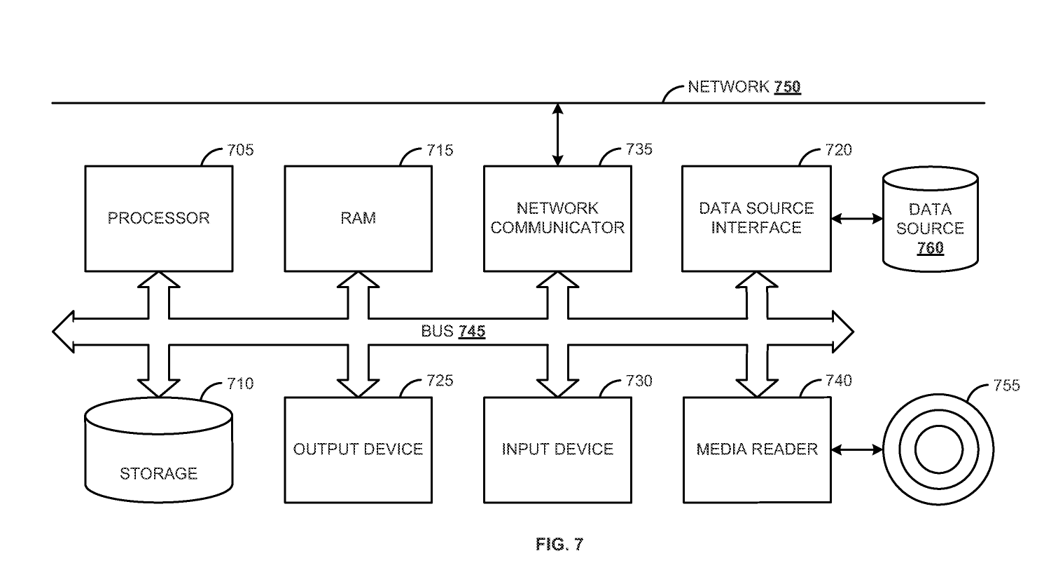

FIG. 7 is a block diagram of an exemplary computer system 700. The computer system 700 includes a processor 705 that executes software instructions or code stored on a computer readable storage medium 755 to perform the above-illustrated methods. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

1. A computer-implemented method of detecting quality of product modules of a product, the method comprising:
integrating, by a computer, error reports received from an internal incident management system and a customer incident management system, wherein the error reports include quality information relating to the product modules;
associating, by the computer, the quality information in the error reports to a respective one of the product modules of the product;
storing the association in a metadata repository; and
evaluating, by the computer, a quality of at least one of the product modules based on the association stored in the metadata repository by:
counting, from the error reports, a number of errors associated with the at least one product module;
measuring a usage index of the at least one product module, wherein the usage index represents a count of code processing during runtime;
determining a relative weight associated with the at least one product module; and
generating a quality indicator for the at least one product module by calculating a quotient of the number of errors and the usage index, and determining a product of the calculated quotient and the relative weight.

2. (canceled)

3. The method of claim 1 further comprising:
storing the generated quality indicator with the respective product modules in the metadata repository with a timestamp;
performing periodic evaluation of the quality information in the metadata repository by:
extracting the quality indicators associated with each of the product modules for a particular stage of a lifecycle of the product modules;
aggregating the quality indicators associated with each of the product modules;
detecting that the aggregated quality indicators for at least one of the product modules exceeds a pre-defined threshold; and
triggering one or more actions, for quality improvement, in response to the detecting.

4. The method of claim 1 further comprising generating a quality report based on the quality indicator(s) in the metadata repository according to one or more schemas.

5. The method of claim 4, wherein the one or more schemas include, product family, product lifecycle, product significance, products with high quality, products with low quality.

6. The method of claim 1 further comprising generating a quality report including quality indicators for each of the product modules over a lifecycle of the product.

7. The method of claim 1, wherein counting, from the error reports, the number of errors associated with the product module comprises classifying the errors into various stages of a lifecycle of the product and counting the number of errors under each classification.

8. The method of claim 7, wherein the various stages of the product lifecycle includes development, ramp-up, testing, release-to-customer, operation, and customer service.

9. The method of claim 1, wherein the customer incident management system receives information about errors occurring in a test system or productive system at a customer premise.

10. An article of manufacture, comprising:
a non-transitory computer readable storage medium having instructions which when executed by a computer causes the computer to:
integrate, at a central quality system, error reports received from an internal incident management system and a customer incident management system, wherein the error reports include quality information relating to product modules of a product;
associate the quality information in the error reports to a respective one of the product modules of the product and store the association in a metadata repository; and
perform automated evaluation of a quality of at least one of the product modules using the association stored in the metadata repository, comprising:
counting, from the error reports, a number of errors associated with the at least one product module;
measuring a usage index of the at least one product module, wherein the usage index represents a count of code processing during runtime;
determining a relative weight associated with the at least one product module; and
generating a quality indicator for the at least one product module by calculating a quotient of the number of errors and the usage index, and determining a product of the calculated quotient and the relative weight.

11. The article of manufacture in claim 10, wherein the computer readable storage medium further comprises instructions, which when executed by the computer causes the computer to:
store the generated quality indicator with the respective one of the product modules in the metadata repository with a timestamp;
perform periodic evaluation of the quality information in the metadata repository by:
extracting the quality indicators associated with each of the product modules across all hierarchical levels;
aggregating the quality indicators associated with each of the product modules;
detecting that the aggregated quality indicators for at least one of the product modules exceeds a pre-defined threshold; and
triggering one or more actions, for quality improvement, in response to the detecting.

12. The article of manufacture in claim 10, wherein the computer readable storage medium further comprises instructions, which when executed by the computer causes the computer to:
generate an analytical report based on the quality indicators in the metadata repository according to one or more schemas.

13. The article of manufacture in claim 12, wherein the one or more schemas include, product family, product lifecycle, product significance, products with high quality, products with low quality.

14. The article of manufacture in claim 10, wherein the computer readable storage medium further comprises instructions, which when executed by the computer causes the computer to generate a quality report including quality indicators for each of the product modules over a lifecycle of the product.

15. The article of manufacture in claim 10, wherein the product modules include hardware components, electronic components, software applications, and software development packages.

16. (canceled)

17. An integrated system operating in a communication network, the system comprising:
one or more data source systems; and
a computer communicatively coupled to the data source systems, comprising a memory to store a program code, and a processor to execute the program code to:
integrate, at a central quality system, error reports received from an internal incident management system and a customer incident management system, wherein the error reports include quality information relating to product modules of a product;
associate the quality information in the error reports to a respective one of the product modules of the product and store the association in a metadata repository; and
perform automated evaluation of a quality of a at least one of the product modules using the association stored in the metadata repository, comprising:
counting, from the error reports, a number of errors associated with the at least one product module;
measuring a usage index of the at least one product module, wherein the usage index represents a count of code processing during runtime;
determining a relative weight associated with the at least one product module; and
generating a quality indicator for the at least one product module by calculating a quotient of the number of errors and the usage index, and determining a product of the calculated quotient and the relative weight.

18. The system of claim 17, wherein the integrated system is an integrated on-demand Enterprise Resource Planning (ERP) system having one or more business modules integrated over the communication network.

19. The system of claim 17, wherein the one or more data source systems includes at least one of an internal test system, a customer system, an incident reporting system, web service, and a data warehouse.

20. The system of claim 17, wherein the internal incident management system is in a hosted environment or an on-demand environment.
